(19) United States
(12) Patent Application Publication
(10) Pub. No.: US 2021/0141562 A1
(43) Pub. Date: May 13, 2021

(54) OUTPUT MANAGEMENT IN COMMAND LINE INTERFACE

(71) Applicant: INTERNATIONAL BUSINESS MACHINES CORPORATION, Armonk, NY (US)

(72) Inventors: Bang Ling Gu, Dezhou (CN); Na Tian, Beijing (CN); Tie Liu, BEIJING (CN); Yong Xin Qi, Beijing (CN); Heng Wang, Beijing (CN)

(21) Appl. No.: 16/681,877

(22) Filed: Nov. 13, 2019

(51) Int. Cl. G06F 3/06

(52) U.S. Cl. CPC G06F 3/0659; G06F 3/0679; G06F 3/0607; G06F 3/0635

(57) ABSTRACT

A method, system and computer program for command output management in a command line interface. The method comprises displaying a prompt for command-inputting in a current line in a first area in the command line interface. The method further comprises receiving a command entered in the current line. And method further comprises displaying an output generated from the execution of the command in a second area separated from the first area in the command line interface.

### BACKGROUND

The present disclosure relates to computer technologies and, particularly, to a method for command output management in a command line interface.

Command line interfaces (CLIs) are widely used in various current operating systems (OS), such as Windows®, Linux®, z/OS®. A CLI is a text-based user interface (UI) used to view and manage computer files in a computer. Typically, the command line interface features a black box with white text. The user responds to a prompt in the command line interface by typing a command with a keyboard to run a task on the computer. The execution of the command may generate an output. The output may include a message, table, list, or some other confirmation information of a system or application action. Conventionally, the output of a command is displayed directly below the corresponding command in a command line in the CLI and a next command is displayed below the output.

### SUMMARY

According to an embodiment of the present disclosure, there is provided a computer-implemented method for command output management in a command line interface. The method comprises displaying a prompt for command-inputting in a current line in a first area in the command line interface. The method further comprises receiving a command entered in the current line. And method further comprises displaying an output generated from the execution of the command in a second area separated from the first area in the command line interface.

According to another embodiment of the present disclosure, there is provided a system for command output management in a command line interface. The system comprises one or more processors and a computer-readable memory coupled to the one or more processors. The computer-readable memory comprises instructions for displaying a prompt for command-inputting in a current line in a first area in the command line interface. The computer-readable memory comprises further instructions for receiving a command entered in the current line. And the computer-readable memory comprises further instructions for displaying an output generated from the execution of the command in a second area separated from the first area in the command line interface.

According to still another embodiment of the present disclosure, there is provided a computer program product for command output management in a command line interface, comprising a computer readable storage medium having program instructions embodied therewith, the program instructions executable by a processor to cause the processor to perform actions of displaying a prompt for command-inputting in a current line in a first area in the command line interface; receiving a command entered in the current line; and displaying an output generated from the execution of the command in a second area separated from the first area in the command line interface.

### BRIEF DESCRIPTION OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 illustratively depicts a conventional command line interface.

FIG. 5 depicts a flowchart of a method according to an embodiment of the present disclosure.

FIGS. 6A to 6F shows example layouts of the command line interface when the method of FIG. 5 is performed according to embodiments of the present disclosure.

FIG. 7 shows an example of log information stored when the method of FIG. 5 is performed according to embodiments of the present disclosure.

FIG. 8 depicts a block diagram of a system architecture in which embodiments of the present disclosure may be implemented.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12 or a portable electronic device such as a communication device, which is operational with numerous other computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to microcode, device drivers, redundant processing units, external disk drive arrays, RAID systems, tape drives, and data archival storage systems, etc.

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and output management in a command line interface 96.

With reference now to accompanying drawings, exemplary embodiments of the present invention will be described. The exemplary embodiments are directed to a method, system and computer program product for command output management in a command line interface.

Turn to FIG. 4, which illustratively depicts a traditional command line interface (CLI) 400. The CLI 400 is initiated by a user to run a task, such as debugging a series of five commands: cd RTC, ls, ls-atl, touch TEST4, and ls-atl. The CLI 400 comprises a plurality of lines (also referred to as “command lines” thereafter) respectively represented by reference numerals 411, 412, 413, 414, 415 and 416, and a plurality of outputs respectively represented by reference numerals 421, 422 and 423.

As is familiar to one skilled in the art, a command line may consist of a prompt and a command. For example, in the line 411, “PATPSM:GUBL:/u/gubl:>” is a prompt that reminds the user to enter a command. And “cd RTC” is a command that is entered by the user in response to the prompt. It is noted that the prompt includes a context information “PATPSM:GUBL:/u/gubl” which is a current working path to which the command is directed. In the instant example, the working path is a file folder.

The process of debugging the five commands is shown in FIG. 4 as follows.

Initially, the prompt “PATPSM:GUBL:/u/gubl:” is displayed in the CLI 400. In response to the prompt, the first command “cd RTC” is entered by the user. The command is displayed following the prompt, as depicted in line 411. The command “cd RTC” is to change the current working path to “PATPSM:GUBL:/u/gubl/RTC”.

The command is executed. As a result, the current working path is changed to “PATPSM:GUBL:/u/gubl/RTC”. Thus, a prompt “PATPSM:GUBL:/u/gubl/RTC:>” is displayed below line 411. In response to the prompt, the second command “ls” is entered by the user. The command is displayed following the prompt, as depicted in line 412. The command is to list contents under the current working path “PATPSM:GUBL:/u/gubl/RTC”.

The command is executed. Output 421 generated from the execution of the command “ls” is displayed below line 412. Output 421 comprises a list of file names, “TEST1 TEST2 TEST3”.

Then, the prompt “PATPSM:GUBL:/u/gubl/RTC:>” is displayed below output 421. In response to the prompt, the third command “ls-atl” is entered by the user. The command is displayed following the prompt, as depicted in line 413. The command is to list information of all files in the current working path. The command is executed. Output 422 generated from the execution of the command “ls-atl” is displayed below line 413.

Then, the prompt “PATPSM:GUBL:/u/gubl/RTC:>” is displayed below output 422. In response to the prompt, the fourth command “touch TEST4” is entered by the user. The command is displayed following the prompt, as depicted in line 414. The command is to create a new file named TEST4 in the current working path. The command is executed, without any output to be displayed.

Then, the prompt “PATPSM:GUBL:/u/gubl/RTC:>” is displayed below line 414. In response to the prompt, the fifth command “ls-atl” is entered by the user. The command is displayed following the prompt, as depicted in line 415. The command is to list information of all files in the current working path. The command is executed. Output 423 generated from the execution of the command “ls-atl” is displayed below line 415.

It is noted that the third command is the same as the fifth command. However, output 422 of the third command is not the same as output 423. Output 423 comprises the following information in addition to the information of output 422:

“-rw-r--r--1 GUBL TESTER 0 Sep 13 00:54 TEST4”,
because of the fourth command “touch TEST4” between the third command and the fifth command.

From the above description with reference to FIG. 4, it may be seen that, in a traditional command line interface such as CLI 400, the prompt for command is automatically displayed at the next line after the last line of the output of the latest command. Command lines 411, 412, 413, 414 and 415 and outputs 421, 422, and 423 are mixed up in a single window. They appear one after another from top to bottom in the order of time.

The configuration of traditional command line interface is not convenient for managing content of the outputs. For example, when reading the history commands and outputs, the user needs to scroll up/down the command line interface window to locate target content. It's not easy to find a keyword in a flood of outputs. Also, it is sometimes not convenient to compare command outputs.

Turn to FIG. 5, which shows a flowchart of a computer-implemented method 500 for managing a command line interface according to an embodiment of the present disclosure. Generally speaking, method 500 comprises steps 510 to 530 that may be executed by one or more processors. Embodiments of the method comprising the steps will be described in detail below with reference to FIG. 6A to FIG. 6F which depict examples of command line interface according to embodiments of the present disclosure.

The process of method 500 may start when a CLI is initiated by a user. For comparison, in the following description, it is assumed that the five commands described with reference to FIG. 4, cd RTC, ls, is-atl, touch TEST4, and is-atl, will be entered and executed by the user.

At step 510, a prompt for command-inputting in a current line is displayed directly in a first area in the command line interface.

Turn to FIG. 6A, which depict an example of command line interface according to an embodiment of the present disclosure. Specifically, FIG. 6A depicts a CLI 600 which provides two separated areas, a first area 610 and a second area 620. In some embodiments, the command line interface may present a display window, and first area 610 and second area 620 can be separated areas located in the display window. In some other embodiments, the command line interface may present two or more display windows, and first area 610 and the second area 620 can be separated areas located in different display windows. Initially, the prompt “PATPSM:GUBL:/u/gubl:>” is displayed in first area 610. Specifically, the prompt is displayed in line 611 in first area 610.

In response to the prompt, the first command “cd RTC” is entered by the user. The command is displayed following the prompt, as also depicted in line 611.

After step 510, step 520 is performed, which involves receiving a command entered in the current line. As mentioned in the above with respect to FIG. 4, the command “cd RTC” is to change the current working path to “PATPSM:GUBL:/u/gubl/RTC”. The command is entered by the user in response to the prompt for command-inputting

The command is executed, resulting in a change of the current working path to “PATPSM:GUBL:/u/gubl/RTC”. For this command, there is no output generated by the command and to be displayed. In this case, no output will be displayed. The process proceeds to step 510 for subsequent commands.

At step 510, the prompt “PATPSM:GUBL:/u/gubl/RTC” is displayed in line 612, which is directly below line 611 in first area 610. In response to the prompt, the second command “ls” is entered by the user. The command is displayed following the prompt, as also depicted in line 612.

Then, at step 520, the command “ls” is received. As mentioned with reference to FIG. 4, the command is to list contents under the current working path. The command is executed. As a result of the execution of the command, contents under the current working path are generated as output to be displayed. In the instant case, the output comprises a list of file names, “TEST1 TEST2 TEST3”.

Thus, step 530 is performed, which involves displaying an output generated from the execution of the command in a second area separated from the first area in the command line interface. In the instant case, the output generated from the execution of the command “ls” is represented by a reference numeral 621. As shown, output 621 is displayed in the second area 620 which is separated from the first area 610.

At the end of step 530, the process proceeds to step 510 for subsequent commands.

At step 510, the prompt “PATPSM:GUBL:/u/gubl/RTC:>” is displayed directly below line 612 in area 610, as depicted in line 613 in FIG. 6B. In response to the prompt, the third command “ls-atl” is entered by the user. The command is displayed following the prompt, as depicted in line 613.

Then, at step 520, the third command “ls-atl” is received. As mentioned previously with reference to FIG. 4, the command is to list information of all files in the current working path. The command is executed.

And, in step 530, output 622 generated from the execution of the command “ls-atl” is displayed in the second area 620, as shown in FIG. 6B.

According to an embodiment of the present disclosure, only the output generated by the current command may be displayed in the second area 620. For example, output 621 is cleared from second area 620 before output 622 is displayed as shown in FIG. 6B.

After step 530, the process proceeds to step 510 for subsequent commands.

At step 510, the prompt “PATPSM:GUBL:/u/gubl/RTC:>” is displayed below line 613, as depicted in line 614. In response to the prompt, the fourth command “touch TEST4” is entered by the user. The command is displayed following the prompt, as also depicted in line 614 in FIG. 6C.

Then, at step 520, the fourth command “touch TEST4” is received. As mentioned previously with reference to FIG. 4, the command “touch TEST4” is to create a new file named TEST4 in the current working path. The command is executed. No output is to be generated.

Thus, at step 530, output 622 (depicted in FIG. 6B) may be cleared from second area 620, as shown in FIG. 6C. Then, the process proceeds to step 510 for subsequent commands.

At step 510, the prompt “PATPSM:GUBL:/u/gubl/RTC:>” is displayed below line 614, as depicted in line 615 in FIG. 6D. In response to the prompt, the fifth command “ls-atl” is entered by the user. The command is displayed following the prompt, as also depicted in line 615.

Then, at step 520, the fifth command “ls-atl” is received. As mentioned previously with reference to FIG. 4, the command is the same as the third command, which is also to list information of all files in the current working path. The command is executed.

And, at step 530, output 623 generated from the execution of the fifth command “ls-atl” is displayed in the second area 620, as shown in FIG. 6D.

Thus, the steps of the general process of method 500 according to an embodiment of the present disclosure are illustrated in the above. It may be noted that, compared to the layout of CLI 400, CLI 600 of the present disclosure provides different areas to display commands and their corresponding outputs. The commands and their outputs are clearly displayed; thus, the readability is improved. Besides, it is relatively convenient for the user to manage command outputs in CLI 600, as shall be describe in detail below.

For example, the user may want to compare the output of the current command with the output of a previous command. In this regard, the layout of CLI 600 may facilitate to make the comparison automatically.

According to an embodiment of an embodiment of the invention, method 500 may further comprise storing the output in association with the command together with a working path to which the command is directed and a timestamp indicating the time when the command is executed.

Information on the five example commands and their corresponding outputs, as well as their working paths and timestamps, may be recorded as log information. And the log information may be stored in a database in the form of a table, such as table 700 shown in FIG. 7.

The information for each command may be stored upon execution of the command after it is entered by the user. For example, after the fifth command “ls-atl” entered by the user is received at step 520 of method 500, as depicted in line 615 in FIG. 6D, the command will be executed. And the command “ls-atl” is stored in association with the output generated as a result of the execution, as shown in the “OUTPUT” column of the 5^{th} item in table 700. The timestamp “2018-09-28 10:10:49:018”, which indicates the point of time when the command is executed, is stored. And the current working path “PATPSM:GUBL:/u/gubl/RTC” to which the command is directed is also stored.

According to an embodiment of the present disclosure, method 500 may further comprises identifying a previous command that is the same as the current command, wherein the previous command and the current command are directed to a same working path. Then, an output of the identified previous command may be compared with the output of the current command to identify their difference. After that, the identified difference may be displayed in the second area.

This is illustrated in FIG. 6E. As shown in FIG. 6E, assume the current command is “ls-atl” in line 615. The command is recorded is in the fifth row of table 700. Method 500 may use the log information stored in table 700 to identify that the third command is a previous command that is same as the current command, and the working path of the third command is also the same as the working path of the current command. Then, the output of the third command is compared with the output of the current command to identify their difference. After the difference is identified, the difference is displayed in the second area. The difference may be rendered in various manners that may be conceived. According to an embodiment of the present disclosure, the identified difference may be displayed either independently or along with the output of the receive command. In the instant case, the difference is that the output of the current command comprises the following information in addition to the information of output of the third command: “-rw-r--r--1 GUBL TESTER 0 Sep 13 00:54 TEST4”. Here, the difference is illustratively displayed below output 623 of the current command in line 615, as represented by the reference numeral 641. In addition, line 613 may be highlighted to show that the third command is same as the fifth command.

According to an embodiment of the present disclosure, method 500 may further comprise retrieving an output of a previous command already displayed in the first area in response to a user action of designating the previous command. The output may be retrieved from the log information. Then, the retrieved output of the previous command is displayed in the second area.

For example, the user may make take a defined action to designate the command “ls-atl” in line 613 shown in FIG. 6E, for example by using a pointer device, such as a mouse, to select or highlight line 613. In response, method 500 may retrieve the output corresponding to the designated command from the log information stored in table 700. Then, the retrieved output is displayed in the second area. This process is illustrated in FIG. 6F. In FIG. 6F, line 613 in the first area 610 has been highlighted by a user action. In response, the output 622 corresponding to the previous command “ls-atl” is retrieved from the log information and displayed in the second area 620.

The method for command output management of command line interface according to embodiments has been described in the above. Now turn to FIG. 8, which depicts a block diagram of a system 800 in which the method of managing command outputs of command line interface may be implemented. As shown in FIG. 8, system 800 comprises an OS shell 810 and a configuration manager 820. Shell 810, which is sometimes referred to as a command processor, is a part of the operating system (OS). Generally, shell 810 is a program that provides an interpreter and an interface between the user and the OS. More specifically, shell 810 can serve as a command interpreter to execute commands entered into a command line interface. Specifically, shell 810 can also provide a system prompt, interpret commands entered by a user using keyboard, mouse, and the like, send the interpreted command(s) to the appropriate levels of the OS for processing. The configuration manager 820 serves to manage the configuration of the command line interface, such as font size of the text in the command line interface.

As shown, system 800 also comprises an output manager 830, a CLI 600 and a log information store 870. Output manager 830 may be a program that provides the functionality of method 500 for command output management of command line interface in addition to shell 810. More specifically, output manager 830 may coordinate with shell 810 so that a conventional command line interface may be transformed into CLI 600 which provides one area 610 for entering commands and another area 620 for displaying command outputs, as described with reference to FIGS. 6A to 6F. Log information store 870 may be used to record log information such as described with reference to table 700 in FIG. 7. The log information may be utilized for enhancing management of command outputs such as described with reference to FIG. 6E.

Embodiments of the present invention have been described and illustrated with specific examples. As may be readily understood from the description, the invention is significantly distinguished from conventional CLI solutions in that that it features two separate areas in a command line interface, one only for inputting and displaying commands and another only for displaying command outputs. It is to be noted that in the illustrative examples, the command line interface provides only one text box. However, it shall not be construed a limitation on the present invention. Instead, the two area may be positioned in different text boxes if they are provided by the command line interface.

It should be noted that the processing for managing command outputs in a command line interface according to embodiments of this disclosure could be implemented by computer system/server 12 of FIG. 1.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for command output management in a command line interface, comprising:
displaying, by one or more processors, a prompt for command-inputting in a current line in a first area in the command line interface;
receiving, by one or more processors, a command entered in the current line; and
displaying, by one or more processors, an output generated from the execution of the command in a second area separated from the first area in the command line interface.

2. The computer-implemented method according to claim 1, further comprising:
storing, by one or more processors, the output in association with the received command together with a working path to which the command is directed and a timestamp indicating the time when the command is executed.

3. The computer-implemented method according to claim 2, further comprising:
identifying, by one or more processors, a previous command that is the same as the received command, wherein the previous command and the received command are directed to a same working path;
comparing, by one or more processors, an output of the previous command with the output of the received command to identify their difference; and
displaying, by one or more processors, the identified difference in the second area.

4. The computer-implemented method according to claim 3, wherein the identified difference is displayed along with the output of the receive command.

5. The computer-implemented method according to claim 2, further comprising:
retrieving, by one or more of processors, an output of a previous command displayed in the first area in response to a user action of for designating the previous command; and
displaying, by one or more of processors, the retrieved output in the second area.

6. The computer-implemented method according to claim 1, wherein displaying the output further comprises:
clearing, by one or more processors, the second area prior to displaying the output.

7. The computer-implemented method according to claim 2, wherein the working path specifies a file folder.

8. A system for command output management in a command line interface, comprising:
one or more processors; and
a computer-readable memory coupled to the one or more processors, the computer-readable memory comprising instructions for:
displaying a prompt for command-inputting in a current line in a first area in the command line interface;
receiving a command entered in the current line; and
displaying an output generated from the execution of the command in a second area separated from the first area in the command line interface.

9. The system according to claim 8, the computer-readable memory further comprising instructions for:
storing the output in association with the command together with a working path to which the command is directed and a timestamp indicating the time when the command is executed.

10. The system according to claim 9, the computer-readable memory comprising instructions for:
identifying a previous command that is the same as the received command, wherein the previous command and the received command are directed to a same working path;
comparing an output of the previous command with the output of the received command to identify their difference; and
displaying the identified difference in the second area.

11. The system according to claim 10, wherein the identified difference is displayed along with the output of the receive command.

12. The system according to claim 9, the computer-readable memory comprising instructions for:
retrieving, by one or more of processors, an output of a previous command displayed in the first area in response to a user action of designating the previous command; and
displaying the retrieved output in the second area.

13. The system according to claim 8, wherein displaying the output further comprises:
clearing the second area prior to displaying the output.

14. The system according to claim 9, wherein the working path specifies a file folder.

15. A computer program product for command output management in a command line interface, comprising a computer readable storage medium having program instructions embodied therewith, the program instructions executable by a processor to cause the processor to perform actions of:
displaying a prompt for command-inputting in a current line in a first area in the command line interface;
receiving a command entered in the current line; and
displaying an output generated from the execution of the command in a second area separated from the first area in the command line interface.

16. The computer program product according to claim 15, the program instructions executable by a processor to cause the processor to perform further actions of:
storing the output in association with the command together with a working path to which the command is directed and a timestamp indicating the time when the command is executed.

17. The computer program product according to claim 16, the program instructions executable by a processor to cause the processor to perform further actions of:
identifying a previous command that is the same as the received command, wherein the previous command and the received command are directed to a same working path;
comparing an output of the previous command with the output of the received command to identify their difference; and
displaying the identified difference in the second area.

18. The computer program product according to claim 17, wherein the identified difference is displayed along with the output of the receive command.

19. The computer program product according to claim 16, the program instructions executable by a processor to cause the processor to perform further actions of:
retrieving, by one or more of processors, an output of a previous command displayed in the first area in response to a user action of designating the previous command; and
displaying the retrieved output in the second area.

20. The computer program product according to claim 15, wherein displaying the output further comprises:
clearing the second area prior to displaying the output.
